(19) United States
(12) Patent Application Publication
(10) Pub. No.: US 2021/0350264 A1
(43) Pub. Date: Nov. 11, 2021

(54) METHOD FOR OBFUSCATED AI MODEL TRAINING FOR DATA PROCESSING ACCELERATORS

(71) Applicant: Baidu USA LLC, Sunnyvale, CA (US)

(72) Inventors: YUEQIANG CHENG, Sunnyvale, CA (US); HEFEI ZHU, Sunnyvale, CA (US)

(21) Appl. No.: 16/869,082

(22) Filed: May 7, 2020

(51) Int. Cl. G06N 7/00; G06N 20/00

(52) U.S. Cl. CPC G06N 7/005; G06N 20/00

(57) ABSTRACT

Embodiments of the disclosure discloses a method to obfuscate AI models. In one embodiment, a host communicates with a data processing (DP) accelerator to request an AI training by the DP accelerator. The DP accelerator (or system) receives an AI model training request from a host, where the AI model training request includes one or more model-obfuscation kernel algorithms, one or more AI models, and/or training input data. In response to receiving the AI model training request, the system trains the one or more AI models based on the training input data. In some embodiments, AI accelerator already has a copy of the AI model. After the AI models are trained, the system obfuscates, using the one or more model-obfuscation kernel algorithms, the one or more trained AI models. The system sends the obfuscated one or more trained AI models to the host.

### TECHNICAL FIELD

Embodiments of the invention relate generally to obscure multiparty computing. More particularly, embodiments of the invention relate to systems and methods obfuscated AI model training for data processing (DP) accelerators.

### BACKGROUND

Sensitive transactions are increasingly being performed by data processing (DP) accelerators such as artificial intelligence (AI) accelerators or co-processors. This increases a need to secure the communication channels between DP accelerators and an environment of a host system to protect the communication channels from data sniffing attacks.

For example, data transmission for AI training data, models, and inference outputs may not be protected and may be leaked to untrusted parties over a communication channel. Furthermore, cryptographic key-based solutions to encrypt data over the communication channels may be slow and may not be practical. Furthermore, most cryptographic key-based solutions require a hardware-based cryptographic-engine. Thus, there is a need for a system to obscure data transmissions for model training using DP accelerators with or without cryptography.

### BRIEF DESCRIPTION OF THE DRAWINGS

Embodiments of the invention are illustrated by way of example and not limitation in the figures of the accompanying drawings in which like references indicate similar elements.

FIG. 1 is a block diagram illustrating an example of system configuration for obscuring a communication between a host and data process (DP) accelerators according to some embodiments.

FIG. 2 is a block diagram illustrating an example of a multi-layer protection solution for obscuring a communication between a host and data process (DP) accelerators according to one embodiment.

FIG. 3 is a block diagram illustrating an example of a host in communication with a DP accelerator according to one embodiment.

FIG. 4 is a flow chart illustrating an example of obfuscating a communication channel between a host and a DP accelerator according to one embodiment.

FIG. 5 is a flow diagram illustrating an example of a method to obfuscate a communication channel according to one embodiment.

FIG. 6 is a flow diagram illustrating an example of a method to request an AI training according to one embodiment.

### DETAILED DESCRIPTION

Various embodiments and aspects of the invention will be described with reference to details discussed below, and the accompanying drawings will illustrate the various embodiments. The following description and drawings are illustrative of the invention and are not to be construed as limiting the invention. Numerous specific details are described to provide a thorough understanding of various embodiments of the present invention. However, in certain instances, well-known or conventional details are not described in order to provide a concise discussion of embodiments of the present inventions.

Reference in the specification to “one embodiment” or “an embodiment” means that a particular feature, structure, or characteristic described in conjunction with the embodiment can be included in at least one embodiment of the invention. The appearances of the phrase “in one embodiment” in various places in the specification do not necessarily all refer to the same embodiment.

According to a first aspect of the disclosure, a host communicates with a data processing (DP) accelerator to request an AI (or machine learning (ML)) training by the DP accelerator. The DP accelerator (or system) receives an AI (or ML) model training request from a host, where the AI model training request includes one or more model-obfuscation kernel algorithms, one or more AI (or ML) models to be trained, and/or training input data. In response to receiving the AI model training request, the system trains the one or more AI models based on the training input data. In some embodiments, AI accelerator already has a copy of the AI model. After the AI models are trained, the system obfuscates, using the one or more model-obfuscation kernel algorithms, the one or more trained AI models. The system sends the obfuscated one or more trained AI models to the host.

According to a second aspect of the disclosure, a system (e.g., the host or an application of the host) generates one or more model-obfuscation kernel algorithms to obfuscate one or more AI models. The system generates a training request to perform an AI training by a data processing (DP) accelerator, where the training request includes training input data, the one or more model-obfuscation kernel algorithms and/or one or more AI models. The system sends the training request to a DP accelerator. In response to the sending, the system receives one or more obfuscated AI models from the DP accelerator. The system de-obfuscates the one or more obfuscated AI models using one or more model-de-obfuscation kernel algorithms corresponding to the one or more model-obfuscation kernel algorithms to retrieve the one or more AI models.

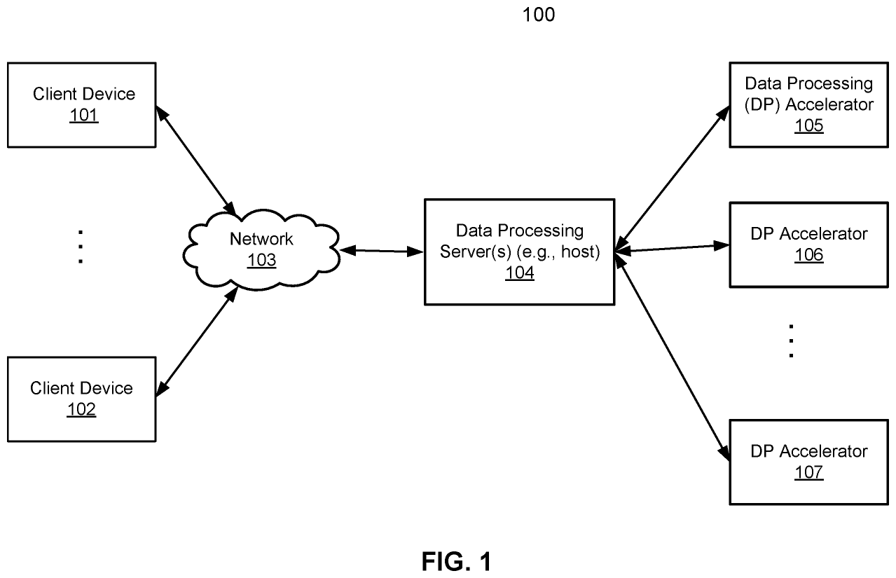

FIG. 1 is a block diagram illustrating an example of system configuration for obscuring a communication between a host and data process (DP) accelerators according to some embodiments. Referring to FIG. 1, system configuration 100 includes, but is not limited to, one or more client devices 101-102 communicatively coupled to DP server 104 over network 103. Client devices 101-102 may be any type of client devices such as a personal computer (e.g., desktops, laptops, and tablets), a “thin” client, a personal digital assistant (PDA), a Web enabled appliance, a Smartwatch, or a mobile phone (e.g., Smartphone), etc. Alternatively, client devices 101-102 may be other servers. Network 103 may be any type of networks such as a local area network (LAN), a wide area network (WAN) such as the Internet, or a combination thereof, wired or wireless.

Server (e.g., host) 104 may be any kind of servers or a cluster of servers, such as Web or cloud servers, application servers, backend servers, or a combination thereof. Server 104 further includes an interface (not shown) to allow a client such as client devices 101-102 to access resources or services (such as resources and services provided by DP accelerators via server 104) provided by server 104. For example, server 104 may be a cloud server or a server of a data center that provides a variety of cloud services to clients, such as, for example, cloud storage, cloud computing services, machine-learning training services, data mining services, etc. Server 104 may be configured as a part of software-as-a-service (SaaS) or platform-as-a-service (PaaS) system over the cloud, which may be a private cloud, public cloud, or a hybrid cloud. The interface may include a Web interface, an application programming interface (API), and/or a command line interface (CLI).

For example, a client, in this example, a user application of client device 101 (e.g., Web browser, application), may send or transmit an instruction (e.g., artificial intelligence (AI) training, inference instruction, etc.) for execution to server 104 and the instruction is received by server 104 via the interface over network 103. In response to the instruction, server 104 communicates with DP accelerators 105-107 to fulfill the execution of the instruction. In some embodiments, the instruction is a machine learning type of instruction where DP accelerators, as dedicated machines or processors, can execute the instruction many times faster than execution by server 104. Server 104 thus can control/manage an execution job for the one or more DP accelerators in a distributed fashion. Server 104 then returns an execution result to client devices 101-102. A DP accelerator or AI accelerator may include one or more dedicated processors such as a Baidu artificial intelligence (AI) chipset available from Baidu, Inc. or alternatively, the DP accelerator may be an AI chipset from NVIDIA, an Intel, or some other AI chipset providers.

According to one embodiment, each of the applications accessing any of DP accelerators 105-107 hosted by data processing server 104 (also referred to as a host) may verify that the application is provided by a trusted source or vendor. Each of the applications may be launched and executed within an execution environment (EE) specifically configured and executed by a central processing unit (CPU) of host 104. When an application is configured to access any one of the DP accelerators 105-107, an obfuscated connection can be established between host 104 and the corresponding one of the DP accelerator 105-107, such that the data exchanged between host 104 and DP accelerators 105-107 is protected against the attacks of sniffing, malwares/intrusions, etc.

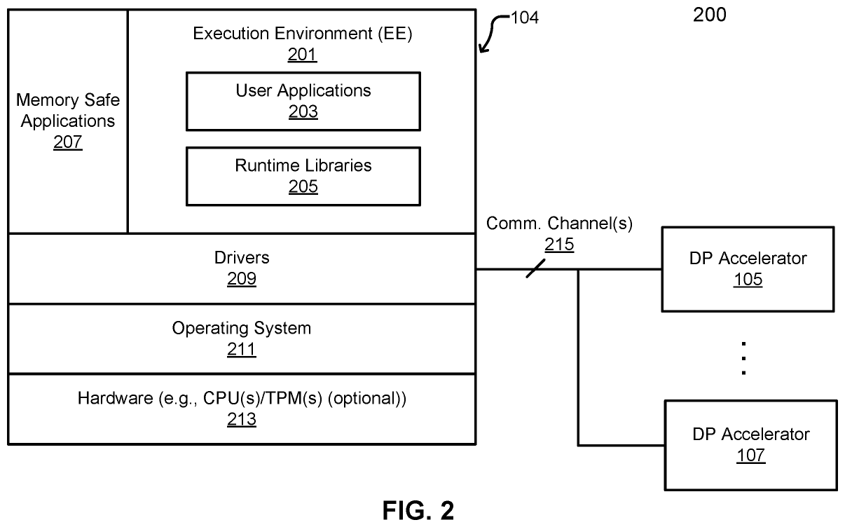

FIG. 2 is a block diagram illustrating an example of a multi-layer protection solution for obscuring a communication between a host and data process (DP) accelerators according to one embodiment. In one embodiment, system 200 provides a scheme for obfuscating a communication between host and DP accelerators without hardware modifications to the DP accelerators. Referring to FIG. 2, host machine or server 104 can be depicted as a system with one or more layers to be protected from intrusion such as user application 203, runtime libraries 205, driver 209, operating system 211, and hardware 213 (e.g., central processing unit (CPU), and optionally, security module(s) (e.g., trusted platform modules (TPMs)). Host machine 104 is typically a CPU system which can control and manage execution jobs on the host machine 104 and/or DP accelerators 105-107. In order to secure/obfuscate a communication channel between DP accelerators 105-107 and host machine 104, different components may be required to protect different layers of the host system that are prone to data intrusions or attacks. For example, an execution environment (EE) can protect the user application layer and the runtime library layer from data intrusions.

Referring to FIG. 2, system 200 includes host system 104 and DP accelerators 105-107 according to some embodiments. DP accelerators can include Baidu AI chipsets or any other AI chipsets such as NVIDIA graphical processing units (GPUs) that can perform AI intensive computing tasks. In one embodiment, host system 104 includes a hardware that has one or more CPU(s) 213 equipped with security module(s) (such as a trusted platform module (TPM)) within host machine 104. A TPM is a specialized chip on an endpoint device that stores cryptographic keys (e.g., RSA cryptographic keys) specific to the host system for hardware authentication. Each TPM chip can contain one or more RSA key pairs (e.g., public and private key pairs) called endorsement keys (EK) or endorsement credentials (EC), i.e., root keys. The key pairs are maintained inside the TPM chip and cannot be accessed by software. Critical sections of firmware and software can then be hashed by the EK or EC before they are executed to protect the system against unauthorized firmware and software modifications. The TPM chip on the host machine can thus be used as a root of trust for secure boot.

The TPM chip also secures driver 209 and operating system (OS) 211 in a working kernel space to communicate with the DP accelerators. Here, driver 209 is provided by a DP accelerator vendor and can serve as a driver for the user application to control a communication channel(s) 215 between host and DP accelerators. Because TPM chip and secure boot protects the OS 211 and drivers 209 in their kernel space, TPM effectively protects the drivers 209 and OS 211 from unauthorized accesses.

Since communication channels 215 for DP accelerators 105-107 may be exclusively occupied by OS 211 and drivers 209, thus, communication channels 215 can be secured through the TPM chip. In one embodiment, communication channels 215 include a peripheral component interconnect or peripheral component interconnect express (PCIE) channel. In one embodiment, communication channels 215 are obscured communication channels.

In one embodiment, host machine 104 can include execution environment (EE) 201 which may be enforced to be secured by TPM/CPU 213. Alternatively, EE can be a standalone container environment. EE can guarantee code and data which are loaded inside the EE to be protected with respect to confidentiality and integrity within the EE. Examples of an EE may be Intel software guard extensions (SGX), or AMD secure encrypted virtualization (SEV), or any non-secured execution environments. Intel SGX and/or AMD SEV can include a set of central processing unit (CPU) instruction codes that allows user-level code to allocate private regions of memory of a CPU that are protected from processes running at higher privilege levels. Here, EE 201 can protect user applications 203 and runtime libraries 205, where user application 203 and runtime libraries 205 may be provided by end users and DP accelerator vendors, respectively. Here, runtime libraries 205 can convert API calls to commands for execution, configuration, and/or control of the DP accelerators. In one embodiment, runtime libraries 205 provides a predetermined set of (e.g., predefined) kernels algorithms for execution by the user applications.

Host machine 104 can include memory safe applications 207 which are implemented using memory safe languages such as Rust, and GoLang, etc. These memory safe applications running on memory safe Linux releases, such as MesaLock Linux, can further protect system 200 from data confidentiality and integrity attacks. However, the operating systems may be any Linux distributions, UNIX, Windows OS, or Mac OS.

The host machine 104 can be set up as follows: A memory-safe Linux distribution is installed onto a system equipped with TPM secure boot. The installation can be performed offline during a manufacturing or preparation stage. The installation can also ensure that applications of a user space of the host system are programmed using memory-safe programming languages. Ensuring other applications running on host system 104 to be memory-safe applications can further mitigate potential memory type of attacks on host system 104.

After installation, the system can then boot up through a TPM-based secure boot. The TPM secure boot ensures only a signed/certified operating system and accelerator driver are launched in a kernel space that provides the accelerator services. In one embodiment, the operating system can be loaded through a hypervisor. Note, a hypervisor or a virtual machine manager is a computer software, firmware, or hardware that creates and runs virtual machines. Note, a kernel space is a declarative region or scope where kernels (i.e., a predetermined set of (e.g., predefined) functions for execution) are identified to provide functionalities and services to user applications. In the event that integrity of the system is compromised, TPM secure boot may fail to boot up and instead shuts down the system.

After secure boot, runtime libraries 205 runs and creates EE 201, which places runtime libraries 205 in a trusted memory space associated with CPU 213. Next, user application 203 is launched in EE 201. In one embodiment, user application 203 and runtime libraries 205 are statically linked and launched together. In another embodiment, runtime 205 is launched in EE first and then user application 205 is dynamically loaded in EE 201. In another embodiment, user application 205 is launched in EE first, and then runtime 205 is dynamically loaded in EE 201. Note, statically linked libraries are libraries linked to an application at compile time. Dynamic loading can be performed by a dynamic linker. Dynamic linker loads and links shared libraries for running user applications at runtime. Here, user applications 203 and runtime libraries 205 within EE 201 can be visible to each other at runtime, e.g., all processes within EE 201 are visible to each other. However, external access to the EE may be denied.

In one embodiment, the user application can only call a kernel (or algorithms) from a set of kernels as predetermined by runtime libraries 205. In another embodiment, the user application and/or runtime can derive or generate additional kernels from the set of kernels. In another embodiment, user application 203 and runtime libraries 205 are hardened with side channel free algorithm to defend against side channel attacks such as cache-based side channel attacks. A side channel attack is any attack based on information gained from the implementation of a computer system, rather than weaknesses in the implemented algorithm itself (e.g. cryptanalysis and software bugs). Examples of side channel attacks include cache attacks which are attacks based on an attacker's ability to monitor a cache of a shared physical system in a virtualized environment or a cloud environment. Hardening can include masking of the cache and/or outputs generated by the kernel algorithms to be placed on the cache. Next, when the user application finishes execution, the user application terminates its execution and exits from the EE.

In one embodiment, implementation of EE 201 and/or memory safe applications 207 is not required, e.g., user application 203 and/or runtime libraries 205 is hosted in an operating system environment of host 104. In one embodiment, the set of kernels include obfuscation kernel algorithms which includes model-obfuscation kernel algorithms and/or any other types of obfuscation kernel algorithms. Here, the model obfuscation kernel algorithms may be dedicated kernel algorithms for obfuscation of AI models and these algorithms may or may not be different from the other types of obfuscation kernel algorithms (e.g., algorithms to obfuscate data other than the AI models, e.g., training input data, inference output data, etc.). Obfuscation refers to obscuring an intended meaning of a communication by making the communication message difficult to understand, usually with confusing and ambiguous language. Obscured data is harder and more complex to reverse engineering. An obfuscation algorithm can be applied before data is communicated to obscure (cipher/decipher) the data communication reducing a chance of eavesdrop.

In one embodiment, the obfuscation kernel algorithms can include different types of algorithms, such as, shift left, shift right, bit rotation (or circular shift), XOR algorithms, etc. to hide any underlying values of an AI model and/or text/binary representations of the AI model. In one embodiment, the model obfuscation kernel algorithms may be randomized or deterministic algorithms. A deterministic algorithm is an algorithm which, given a particular input, will always produce the same output. A randomized algorithm is an algorithm which employs randomness as part of its logics.

In one embodiment, the model obfuscation kernel algorithms can be symmetric or asymmetric algorithms. A symmetric obfuscation algorithm can obfuscate and de-obfuscate data communications using a same algorithm. An asymmetric obfuscation algorithm requires a pair of algorithms, where a first of the pair is used to obfuscate and the second of the pair is used to de-obfuscate. Here, a corresponding model de-obfuscation kernel algorithm can be generated for each model obfuscation kernel algorithm to revert the obfuscation to retrieve an AI model. In another embodiment, an asymmetric obfuscation algorithm includes a single obfuscation algorithm used to obfuscate a data set but the data set is not intended to be de-obfuscated, e.g., there is absent a counterpart de-obfuscation algorithm.

In one embodiment, the obfuscation algorithm can further include an encryption scheme to further encrypt the obfuscated data for an additional layer of protection. Unlike encryption, which may be computationally intensive, obfuscation algorithms may simplify the computations. Some obfuscation techniques can include but are not limited to, letter obfuscation, name obfuscation, binary/data obfuscation, control flow obfuscation, etc. Letter obfuscation is a process to replace one or more letters in a data with a specific alternate letter, rendering the data meaningless. Examples of letter obfuscation include a letter rotate function, where each letter is shifted along, or rotated, a predetermine number of places along the alphabet. Another example is to reorder or jumble up the letters based on a specific pattern. Name obfuscation is a process to replace specific targeted strings with meaningless strings. Binary obfuscation obfuscates the values of the AI model in its binary representations. Control flow obfuscation can change the order of control flow in a program with additive code (insertion of dead code, inserting uncontrolled jump, inserting alternative structures) to hide a true control flow of an algorithm/AI model.

For example, an AI model can be stored as text-based or binary file formats as columnar, tabular, nested, array-based, and hierarchical, etc. values. An obfuscation algorithm may be a circular shift algorithm applied to circular shift to data containers of the AI models. The data containers may be in single-precision (32-bit) floating point format, half precision floating point format, or any other formats. The container can store the values for the column, table, nested, array-based, hierarchical, and/or binary representation values of the AI models. For example, if the weights/bias values of an AI model are stored as data containers of a 32 bit-binary representation, the algorithm can circular shift left by 5 bit the binary bits of the data containers to obscure the values of the data containers. This way, the weights/bias values of the AI model is obscured.

In another embodiment, each data container of the columns, tabular, nested, array-based, and hierarchical values of the AI model can be applied a different obfuscation algorithm. E.g., if the AI model is an array-based value, array[0] may be applied a circular rotate left, array[1] may be applied a circular rotate right algorithm, and so forth. In another embodiment, different columns, tabular, nested, array-based, and hierarchical values can be applied an algorithm to a different degree. E.g., array[0] may be circular rotated left by ‘3’, while array[1] may be circular rotated right by ‘5’. Here, the types and the degrees of algorithm can be stored as a metadata mapping the data containers for the AI models, and which algorithm and to what degree is applied to each of the data containers. In one embodiment, the underlying values of the AI models, such as weight and/or bias values, the number of layers, the types of activation functions, connections to the layers, and/or the ordering of the layers of an AI model can each be obfuscated based on the metadata mapping.

For example, a nesting or connections of an AI model can be tabulated to show which nodes of a current layer is connected with which nodes in a subsequent layer. These tabulations representing the AI model node connections that can be obfuscated to obscure the node connections of the AI model. An example of a node connection obfuscation can be: node 1 of layer 1 is connected to node 1 of layer 2, node 1 of layer 1 may be obscured to connect to node 3 of layer 8 according to a node connection obfuscation scheme, etc. Further, weight/bias values of each individual node can be mapped to a type of algorithm (e.g., circular shift left) and a degree (e.g., by 5 bits) of algorithm for obfuscation. Although some examples are shown, the obfuscation algorithms should not be construed as limiting.

In summary, system 200 provides multiple layers of protection for DP accelerators (for data transmissions including machine learning models, training data, and inference outputs) from loss of data confidential and integrity. System 200 can include a TPM-based secure boot protection layer, a EE layer, and a kernel validation/verification layer. Furthermore, system 200 can provide a memory safe user space by ensuring other applications on the host machine are implemented with memory-safe programming languages, which can further eliminate attacks by eliminating potential memory corruptions/vulnerabilities. Moreover, system 200 can include applications that use side-channel free algorithms so to defend against side channel attacks, such as cache based side channel attacks.

Lastly, runtime can provide obfuscation kernel algorithms to obfuscate data communication between a host and DP accelerators. In one embodiment, the obfuscation can be pair with a cryptography scheme. In another embodiment, the obfuscation is the sole protection scheme and cryptography-based hardware is rendered unnecessary for the DP accelerators.

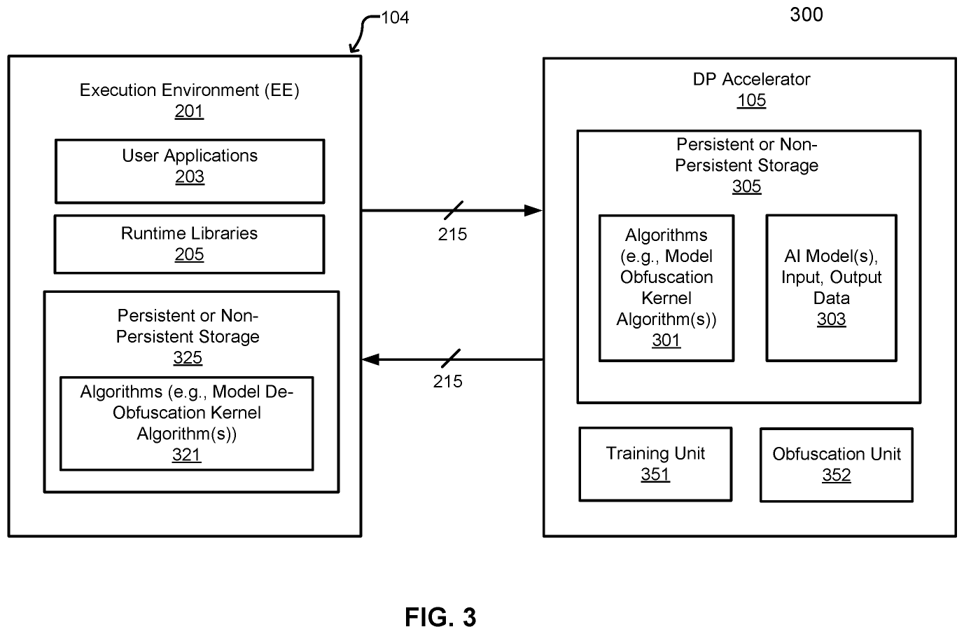

FIG. 3 is a block diagram illustrating an example of a host in communication with a DP accelerator according to one embodiment. Here, an obfuscation scheme in the communication does not require cryptography-based hardware for either the host or the DP accelerator. Moreover, the obfuscation algorithms can be applied to only the AI models but not the training data inputs or inference output. Referring to FIG. 3, system 300 can include EE 201 of host 104 in communication with DP accelerator 105.

EE 201 of host 104 can include user application 203, runtime libraries 205, and persistent or non-persistent storage 325. Storage 325 can include a storage space for algorithms 321, such as model obfuscation and/or de-obfuscation kernel algorithms. DP accelerator 105 can include persistent or non-persistent storage 305, training unit or logic 351, and obfuscation unit or logic 352. Storage 305 can include a storage space for obfuscation kernel algorithms 301 and a storage space for other data (e.g., AI models, inputs/output data 303). User applications 203 of host 104 can establish obscured communication (e.g., obfuscated and/or encrypted) channel(s) 215 with DP accelerator 105.

The obscured communication channel(s) 215 can be established for the DP accelerator 105 to transmit trained AI models to host 104. Here, host 104 can establish the obscured communication channel by generating one or more model-obfuscation kernel algorithms (and/or corresponding de-obfuscation kernel algorithms). In one embodiment, host 104 can generate a metadata mapping the types and degrees of obfuscation algorithms to be applied, and to which portions of the AI model. Host 104 then sends the model-obfuscation algorithms to a DP accelerator (e.g., DP accelerator 105).

In another embodiment, when the communication channel drops or terminates, the obfuscation algorithm may re-establish, where a derived obfuscation algorithm is generated by host 104 and/or DP accelerator 105 for the communication channel. In another embodiment, the obfuscation algorithm(s)/scheme(s) for channel 215 is different than the obfuscation scheme(s) for other channels between host 104 and other DP accelerators (e.g., DP accelerators 106-107). In one embodiment, host 104 includes an obfuscation interface that stores the obfuscation algorithms for each communication sessions of DP accelerators 105-107. Although the obscured communication is shown between host 104 and DP accelerator 105, the obscured communication (e.g., obfuscation) can be applied to other communication channels, such as a communication channel between clients 101-102 and host 104.

In one embodiment, training unit 351 is configured to train an AI model received from host 104 using the set of input data 303. Obfuscation unit 352 is configured to obfuscate the AI model using the model obfuscation kernel algorithm(s).

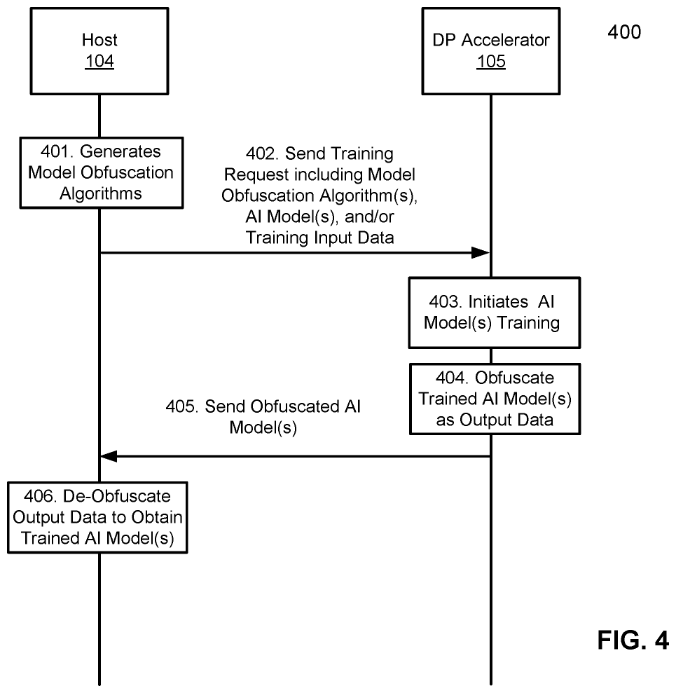

FIG. 4 is a flow chart illustrating an example of an obfuscation communication protocol between a host and a DP accelerator according to one embodiment. Referring to FIG. 4, operations 400 for the protocol may be performed by system 100 of FIG. 1 or system 300 of FIG. 3. In one embodiment, a client device, such as client device (e.g., a client/user) 101, requests to train an AI model. Here, the AI model can be any types of AI models, including, but not limited, support vector machine, linear regression, random forest, machine learning neural networks (e.g., deep, convolutional, recurrent, long short term memory single layer perceptron, etc.), etc. For example, the training can be an optimization process to calculate different weight and/or bias values of a neural network for the AI model. The AI model can be trained based on a previously trained AI model (e.g., pre-trained AI model) or a new AI model. Here a new AI model can be generated by DP accelerator 105 for the training.

At operation 401, host 104 generates one or more model-obfuscation kernel algorithms and/or model-de-obfuscation kernel algorithms to obfuscate and de-obfuscate an AI model. The obfuscation algorithm can be any types of obfuscation algorithms. The algorithm can be symmetric or asymmetric, randomized or deterministic. In one embodiment, host 104 generates a metadata corresponding to the algorithms for a training session to train the AI model. The metadata can indicate the types of obfuscation algorithms, the degrees (or input values to the obfuscation algorithms), and/or which portions of the AI model to be obscured.

At operation 402, host 104 (representing client 101 or an application hosted on host 104) sends an AI model training request to DP accelerator 105. The training request is a request to perform a training by any DP accelerators, here, DP accelerator 105. In one embodiment, the training request includes the model-obfuscation kernel algorithms, the associated metadata, and optionally, training input data, and/or an AI model (e.g., a new model to be trained or a previously trained model to be trained again).

At operation 403, in response to receiving the request, DP accelerator 105 initiates an AI model training session based on the AI model and the training input data, which can be performed by training unit 351 of DP accelerator 105. In one embodiment, DP accelerator 105 generates a new AI model for the training.

At operation 404, after the training completes, DP accelerator 105 processes the training data to generate a trained AI model. DP accelerator 105 obfuscates the trained AI model using the model-obfuscation kernel algorithms received from host 104 from operation 402. The obfuscation process may be performed by obfuscation unit 352 of DP accelerator 105. In one embodiment, a metadata corresponding to the model-obfuscation kernel algorithms can be retrieved to determine the types (e.g., circular shift left), the degree (e.g., shift by 5) of obfuscation to apply to which portion (e.g., layer 1, node 1) of the trained AI model.

In one embodiment, the metadata indicates a storage format for the AI models. In another embodiment, the metadata itself is further obscured by a metadata obfuscation algorithm. The metadata obfuscation algorithm may be an algorithm previously agreed upon by host 104 and by each of the DP accelerators. In one embodiment, the metadata obfuscation algorithm may be a deterministic algorithm. Although the AI models illustrated in the above examples are neural networks, this should not be construed as limiting.

In one embodiment, the metadata can be a JavaScript Object Notation (JSON), xml, or any text-based and/or binary file. For example, the metadata can be a JSON file with node branches specifying the nodes/layers of the AI model. In one embodiment, the metadata can include the type of obfuscation algorithm, the degree as name/value pairs for each of the JSON nodes. This way, the metadata can indicate what algorithm to be applied to the nodes (here, the nodes can be, e.g., weight and/or bias values). For example, a node (e.g., weight and/or bias values of a first node for a first layer) can be applied a circular left shift for 5 bits while another node (e.g., weight and/or bias values of a second node for a second layer) of the AI model is to be applied a circular right shift for 3 bits. Thus, the model-obfuscation kernel algorithms can be applied to portions of an AI model based on the metadata information specifying the different types of algorithms (shift left, shift right, or other obfuscation algorithm, etc.), the degrees of obfuscation (e.g., shift by how many bits).

In one embodiment, the model-obfuscation kernel algorithm(s) are time expiring algorithms that expire after some predetermined periods of time have lapsed. For example, the algorithm may expire after a few hours, days, or weeks. If a model-obfuscation kernel algorithm expires, a derived model-obfuscation kernel algorithm may be generated by the DP accelerator and/or host to replace the expired algorithm. In one embodiment, the metadata specifies the predetermined periods of time before the one or more model-obfuscation kernel algorithms expire. In another embodiment, the metadata specifies the instructions to generate the derived model-obfuscation kernel algorithm according to expiration times.

The instruction can be deterministic instructions (for a threshold number of derived model-obfuscation kernel algorithm) that are agreed upon by host 104 and the DP accelerators. This way, when the algorithm expires, both the host and the DP accelerator can generate derived obfuscation/de-obfuscation kernel algorithms and use the derived obfuscation/de-obfuscation kernel algorithms to obfuscate/de-obfuscation an AI model. For example, a circular right shift for 3 bits when expired may generate a derived algorithm of circular right shift for 2 bits. The derived algorithm of circular right shift for 2 bits when expired, may generate a second derived algorithm of circular right shift for 1 bit, and so forth, according to an agreed upon derivation scheme.

In operation 405, DP accelerator 105 sends the obfuscated AI model to host 104. In one embodiment, DP accelerator 105 sends a receipt to host 104 specifying a status of the request. In operation 406, in response to receiving the obfuscated AI model, host 104 de-obfuscates the obfuscated AI model using a corresponding de-obfuscation kernel algorithm to obtain the AI model. In one embodiment, the obfuscation kernel algorithm is a symmetric algorithm and the corresponding de-obfuscation kernel algorithm is same as the obfuscation kernel algorithm. In another embodiment, the kernel algorithm is an asymmetric algorithm and the corresponding de-obfuscation kernel algorithm is different than the obfuscation kernel algorithm. In one embodiment, DP accelerator 105 sent a receipt to host 104 specifying a status of the request and host 104 can determine the corresponding de-obfuscation kernel algorithm based on the receipt.

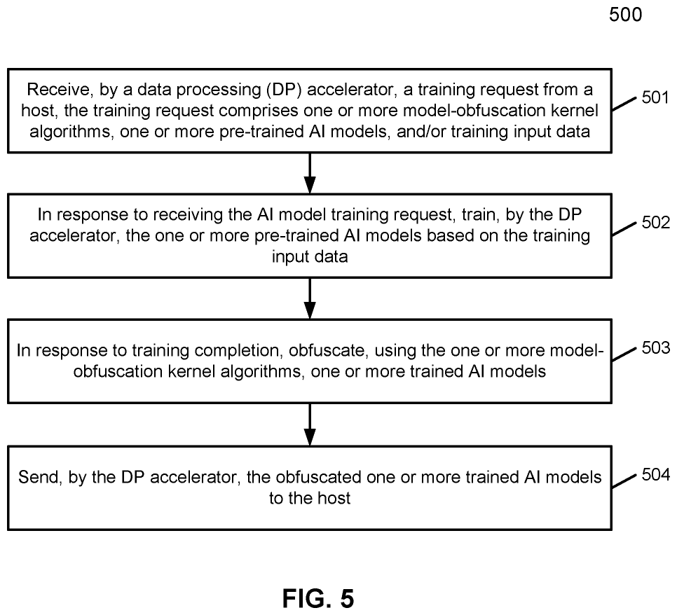

FIG. 5 is a flow diagram illustrating an example of a method to obfuscate a communication channel according to one embodiment. Process 500 may be performed by processing logic which may include software, hardware, or a combination thereof. For example, process 500 may be performed by a DP accelerator, such as DP accelerator 105 of FIG. 1. Referring to FIG. 5, at block 501, processing logic (e.g., DP accelerator) receives an AI model training request from a host, where the AI model training request includes one or more model-obfuscation kernel algorithms, one or more AI models, and/or training input data. At block 502, in response to receiving the AI model training request, processing logic trains the one or more AI models based on the training input data. At block 503, in response to training completion, processing logic obfuscates, using the one or more model-obfuscation kernel algorithms, one or more trained AI models. At block 503, processing logic sends the obfuscated one or more trained AI models to the host.

In one embodiment, the one or more model-obfuscation kernel algorithms are generated by the host, and where one or more corresponding model-de-obfuscation kernel algorithms are used by the host to de-obfuscate the obfuscated one or more AI models to retrieve the one or more AI models. In one embodiment, the one or more model-obfuscation kernel algorithms are received on a same communication channel as the training request.

In one embodiment, the one or more model-obfuscation kernel algorithms include a shift left or shift right algorithm applied to bit representations for weight and/or bias values of the one or more AI models. In one embodiment, the one or more model-obfuscation kernel algorithms include a deterministic algorithm or a probabilistic algorithm.

In one embodiment, the one or more model-obfuscation kernel algorithms are expiring algorithms that expire after some predetermined periods of time have lapsed, where if a model-obfuscation kernel algorithm expires, a derived model-obfuscation kernel algorithm is to replace the expired algorithm. In one embodiment, the training request includes a metadata specifying the predetermined periods of time before the one or more model-obfuscation kernel algorithms expire.

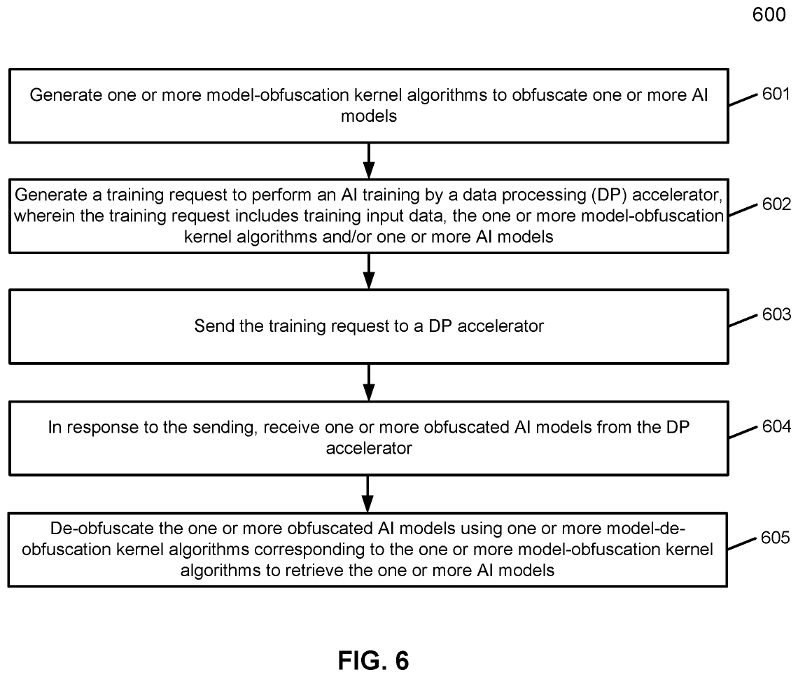

FIG. 6 is a flow diagram illustrating an example of a method to request an AI training according to one embodiment. Process 600 may be performed by processing logic which may include software, hardware, or a combination thereof. For example, process 600 may be performed by a host, such as host 104 of FIG. 1. Referring to FIG. 6, at block 601, processing logic (e.g., host) generates one or more model-obfuscation kernel algorithms to obfuscate one or more AI models. At block 602, processing logic generates a training request to perform an AI training by a data processing (DP) accelerator, wherein the training request includes training input data, the one or more model-obfuscation kernel algorithms and/or one or more AI models. At block 603, processing logic sends the training request to a DP accelerator. At block 604, in response to the sending, processing logic receives one or more obfuscated AI models from the DP accelerator. At block 605, processing logic de-obfuscates the one or more obfuscated AI models using one or more model-de-obfuscation kernel algorithms corresponding to the one or more model-obfuscation kernel algorithms to retrieve the one or more AI models.

In one embodiment, the one or more model-obfuscation kernel algorithms are used by the DP accelerator to obfuscate the one or more AI models that has been trained. In one embodiment, the one or more model-obfuscation kernel algorithms are sent on a same communication channel as the training request.

In one embodiment, the one or more model-obfuscation kernel algorithms include a shift left or shift right algorithm applied to bit representations for weight and/or bias of the one or more AI models. In one embodiment, the one or more model-obfuscation kernel algorithms include a deterministic algorithm or a probabilistic algorithm.

In one embodiment, the one or more model-obfuscation kernel algorithms are expiring algorithms that expire after some predetermined periods of time have lapsed. If a model-obfuscation kernel algorithm expires, a derived model-obfuscation kernel algorithm is to replace the expired algorithm. In one embodiment, the training request includes a metadata specifying the predetermined periods of time before the one or more model-obfuscation kernel algorithms expire.

Note that some or all of the components as shown and described above may be implemented in software, hardware, or a combination thereof. For example, such components can be implemented as software installed and stored in a persistent storage device, which can be loaded and executed in a memory by a processor (not shown) to carry out the processes or operations described throughout this application. Alternatively, such components can be implemented as executable code programmed or embedded into dedicated hardware such as an integrated circuit (e.g., an application specific IC or ASIC), a digital signal processor (DSP), or a field programmable gate array (FPGA), which can be accessed via a corresponding driver and/or operating system from an application. Furthermore, such components can be implemented as specific hardware logic in a processor or processor core as part of an instruction set accessible by a software component via one or more specific instructions.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments of the disclosure also relate to an apparatus for performing the operations herein. Such a computer program is stored in a non-transitory computer readable medium. A machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

The processes or methods depicted in the preceding figures may be performed by processing logic that comprises hardware (e.g. circuitry, dedicated logic, etc.), software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

Embodiments of the present disclosure are not described with reference to any particular programming language. It will be appreciated that a variety of programming languages may be used to implement the teachings of embodiments of the disclosure as described herein.

In the foregoing specification, embodiments of the disclosure have been described with reference to specific exemplary embodiments thereof. It will be evident that various modifications may be made thereto without departing from the broader spirit and scope of the disclosure as set forth in the following claims. The specification and drawings are, accordingly, to be regarded in an illustrative sense rather than a restrictive sense.

What is claimed is:

1. A method to obfuscate artificial intelligence (AI) models, the method comprising:
receiving, by a data processing (DP) accelerator, an AI model training request from a host, wherein the AI model training request comprises one or more model-obfuscation kernel algorithms, one or more AI models, and/or training input data;
in response to receiving the AI model training request, training, by the DP accelerator, the one or more AI models based on the training input data;
in response to training completion, obfuscating, using the one or more model-obfuscation kernel algorithms, one or more trained AI models; and
sending, by the DP accelerator, the obfuscated one or more trained AI models to the host.

2. The method of claim 1, wherein the one or more model-obfuscation kernel algorithms are generated by the host, and wherein one or more corresponding model-de-obfuscation kernel algorithms are used by the host to de-obfuscate the obfuscated one or more AI models to retrieve the one or more AI models.

3. The method of claim 1, wherein the one or more model-obfuscation kernel algorithms are received on a same communication channel as the training request.

4. The method of claim 1, wherein the one or more model-obfuscation kernel algorithms include a shift left or shift right algorithm applied to data containers for weight and/or bias values of the one or more AI models.

5. The method of claim 1, wherein the one or more model-obfuscation kernel algorithms include a deterministic algorithm or a probabilistic algorithm.

6. The method of claim 1, wherein the one or more model-obfuscation kernel algorithms are expiring algorithms that expire after some predetermined periods of time have lapsed, wherein if a model-obfuscation kernel algorithm expires, a derived model-obfuscation kernel algorithm is to replace the expired algorithm.

7. The method of claim 6, wherein the training request includes a metadata specifying the predetermined periods of time before the one or more model-obfuscation kernel algorithms expire.

8. A data processing (DP) accelerator, comprising:
an interface to receive an AI model training request from a host, wherein the AI model training request comprises one or more model-obfuscation kernel algorithms, one or more AI models, and training input data;
a training unit, in response to receiving the AI model training request, to train the one or more AI models based on the training input data; and
an obfuscation unit to obfuscate one or more trained AI models using the one or more model-obfuscation kernel algorithms and to send the obfuscated one or more trained AI models to the host.

9. The DP accelerator of claim 8, wherein the one or more model-obfuscation kernel algorithms are generated by the host, and wherein one or more corresponding model-de-obfuscation kernel algorithms are used by the host to de-obfuscate the obfuscated one or more AI models to retrieve the one or more AI models.

10. The DP accelerator of claim 8, wherein the one or more model-obfuscation kernel algorithms are received on a same communication channel as the training request.

11. The DP accelerator of claim 8, wherein the one or more model-obfuscation kernel algorithms include a shift left or shift right algorithm applied to bit representations for weight and/or bias of the one or more AI models.

12. The DP accelerator of claim 8, wherein the one or more model-obfuscation kernel algorithms include a deterministic algorithm or a probabilistic algorithm.

13. The DP accelerator of claim 8, wherein the one or more model-obfuscation kernel algorithms are expiring algorithms that expire after some predetermined periods of time have lapsed, wherein if a model-obfuscation kernel algorithm expires, a derived model-obfuscation kernel algorithm is to replace the expired algorithm.

14. The DP accelerator of claim 13, wherein the training request includes a metadata specifying the predetermined periods of time before the one or more model-obfuscation kernel algorithms expire.

15. A method to de-obfuscate artificial intelligence (AI) models, the method comprising:
generating one or more model-obfuscation kernel algorithms to obfuscate one or more AI models;
generating a training request to perform an AI training by a data processing (DP) accelerator, wherein the training request includes training input data, the one or more model-obfuscation kernel algorithms and one or more AI models;
sending the training request to a DP accelerator;
in response to the sending, receiving one or more obfuscated AI models from the DP accelerator; and
de-obfuscating the one or more obfuscated AI models using one or more model-de-obfuscation kernel algorithms corresponding to the one or more model-obfuscation kernel algorithms to retrieve the one or more AI models.

16. The method of claim 15, wherein the one or more model-obfuscation kernel algorithms are used by the DP accelerator to obfuscate the one or more AI models that has been trained.

17. The method of claim 15, wherein the one or more model-obfuscation kernel algorithms are sent on a same communication channel as the training request.

18. The method of claim 15, wherein the one or more model-obfuscation kernel algorithms include a shift left or shift right algorithm applied to bit representations for weight and/or bias of the one or more AI models.

19. The method of claim 15, wherein the one or more model-obfuscation kernel algorithms include a deterministic algorithm or a probabilistic algorithm.

20. The method of claim 15, wherein the one or more model-obfuscation kernel algorithms are expiring algorithms that expire after some predetermined periods of time have lapsed, wherein if a model-obfuscation kernel algorithm expires, a derived model-obfuscation kernel algorithm is to replace the expired algorithm.

21. The method of claim 20, wherein the training request includes a metadata specifying the predetermined periods of time before the one or more model-obfuscation kernel algorithms expire.
